(19) United States
(12) Patent Application Publication
(10) Pub. No.: US 2004/0080157 A1
(43) Pub. Date: Apr. 29, 2004

(54) Pipe fitting for a panel, especially for a panel of a lid or container

(76) Inventors: Olav Borgmeier, Hambuchener Weg (DE); Harald Hagen, Wipperfurth (DE)

Correspondence Address: Brinks Hofer Gilson & Lione, P.O. Box 10395, Chicago, IL, 60610, US

(21) Appl. No.: 10/318,939

(22) Filed: Dec. 11, 2002

(30) Foreign Application Priority Data
Dec. 11, 2001 (DE) 201 20 029.5
Jan. 25, 2002 (DE) 202 01 112.7

(51) Int. Cl. F16L 5/00

(52) U.S. Cl. 285/189; 285/222

(57) ABSTRACT

The present invention provides for a pipe fitting for a panel, especially for a panel of a lid for a container, as on a container wall. A pipe section protruding from the panel is provided wherein the front of the pipe fitting is fastened to the panel in the assembled state. A flange having a groove for a seal and a pipe socket extend from the pipe section for passing through an opening in the panel. The pipe socket forms a positive fit connection to the panel through deformation to the assembled state and the seal provides a non-positive fit against a surface of the panel.

### BACKGROUND OF THE INVENTION

### Field of the Invention

The present invention relates to a pipe fitting for a panel, especially for a panel of a lid or container with one pipe section protruding from the panel. The panel can preferably be the wall of a pressure reservoir from which the pipe section protrudes outwards.

Well-known pipe fittings of this type, particularly pipe fittings that are integrally attached to the panel, form the state of the art. DE 3520161C2 describes a mechanized process for welding thick-walled pipe fittings to cylindrical container sections. Moreover, pipe fittings that feature a pipe thread which screw into a threaded hole of a container wall, and valves for tubeless vehicle tires in which a rubber body is inserted into the wheel, are also known.

In these types of connections, it is necessary that either the pipe fitting be attached to the lid or container wall prior to a surface treatment, such as a coat of paint, or that the panel be accessible from both sides for assembly. Otherwise, it is not possible to achieve adequate sealing, especially when the container holds a fluid under pressure.

### SUMMARY OF THE INVENTION

It is the objective of the present invention to create a pipe fitting of the abovementioned art that can be fastened into the panel when the container is in its final state of handling and that simultaneously guarantees the required sealing effect.

This is accomplished in accordance with the invention, by a pipe fitting of the abovementioned type in which the front of the pipe section is fastened tight to the panel in the assembled state, an intermediate layer forming a seal and a pipe socket on the pipe section are provided for passing through an opening in the panel, which pipe socket forms a connection to the panel in the assembled state without axial play and a positive fit.

According to invention, joining of the pipe fitting can first occur after the panel has been manufactured and given a surface treatment. The lid or container wall has a simple through-hole for this purpose, its edge providing a surface upon which the seal, perhaps an O-ring or profile ring, can seal. When manufacturing a lid or container, it is easy in product engineering to punch such a hole before painting. But a drilling machine could also still form such a hole after painting. The wall should be flat or should not drop below a minimum radius so that the seal can seal the panel. If a minimum radius is not met, a spot facing can be attached to the borehole, something which a shape drill can accomplish in one working cycle when drilling the through-hole.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a longitudinal section through a first embodiment of a fully assembled pipe fitting according to the invention including two connecting pieces in an intermediate stage of assembly;

FIG. 2 is a drawing corresponding to FIG. 1 of a first embodiment of a pipe fitting according to the invention depicted in FIG. 1 in a final stage of assembly;

FIG. 3 is a sectional drawing corresponding to FIG. 2 of a second embodiment of a pipe fitting according to the invention in the final stage of assembly;

FIG. 4 is a view corresponding to FIG. 1 of a third embodiment of a pipe fitting according to the invention in an intermediate stage of assembly;

FIG. 5 is a view corresponding to FIG. 2 of a third embodiment of a pipe fitting according to the invention in a final stage of assembly;

FIG. 6 is an exploded perspective drawing, a longitudinal section through a fourth embodiment of a fully assembled pipe fitting according to the invention including a connecting piece;

FIG. 7 is a drawing corresponding to FIG. 6, of the fourth embodiment of a pipe fitting according to the invention in an intermediate stage of assembly;

FIG. 8 is a drawing corresponding to FIG. 7 of the fourth embodiment of a pipe fitting according to the invention in the final stage of assembly;

FIG. 9 is an exploded perspective drawing, of a fifth embodiment of a fully assembled pipe fitting according to the invention including a connecting piece;

FIG. 10 is a sectional drawing corresponding to FIG. 8 of the fifth embodiment of a pipe fitting according to invention in the final stage of assembly;

FIG. 11 is an exploded perspective drawing a view of a sixth embodiment of a pipe fitting according to the invention including a connecting piece in an intermediate stage of assembly;

FIG. 12 is a sectional drawing corresponding to FIG. 7 of the sixth embodiment of a pipe fitting according to the invention in the intermediate stage of assembly;

FIG. 13 is a sectional drawing corresponding to FIGS. 8 and 10 of the sixth embodiment of a pipe fitting according to the invention in the final stage of assembly;

FIG. 14 is a sectional drawing of a seventh embodiment of a pipe fitting according to the invention;

FIG. 15 is a sectional drawing of the seventh embodiment of a pipe fitting according to the invention in the final stage of assembly together with the pressure reservoir in which the pipe fitting is mounted; and

FIG. 16 is an enlarged drawing relative to FIG. 15 of the seventh embodiment of a pipe fitting according to the invention in the final stage of assembly.

### DETAILED DESCRIPTION OF THE INVENTION

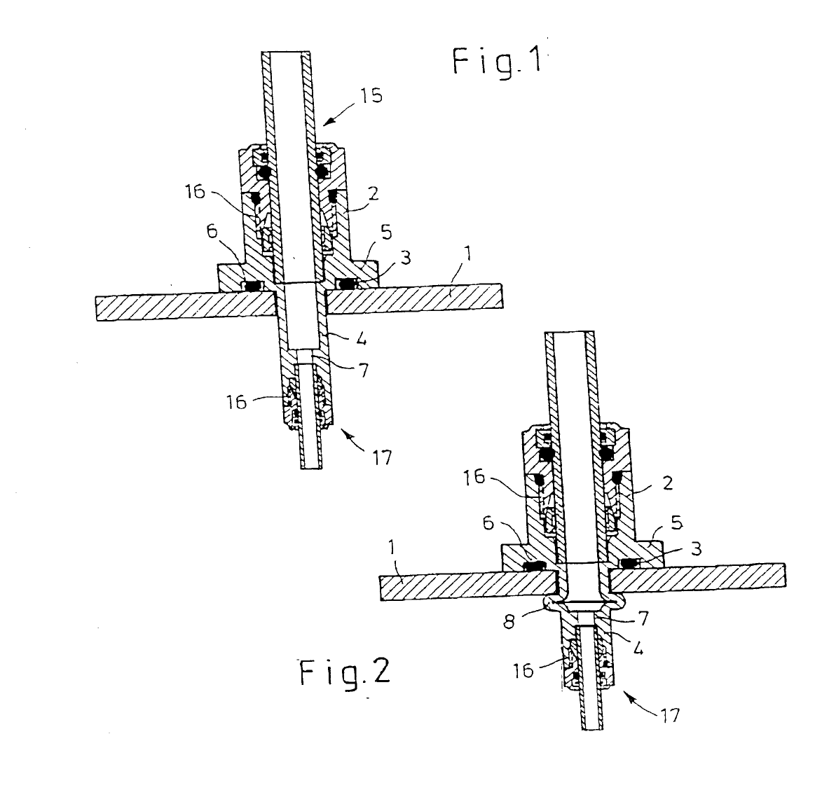

FIGS. 1 and 2 show a first embodiment of the present invention, a pipe fitting for a panel 1 of a lid or container, including a pipe section 2 protruding from the panel 1. The pipe section 2 can protrude into the interior of the lid, container or the like or protrude outwards.

In its assembled state, the front of the pipe section 2 is tightly fastened to the panel 1 by the intermediate layer of a seal 3. A pipe socket 4 is provided on the pipe section 2 for passing through an opening (not illustrated in detail) in panel 1. Pipe socket 4 fits the size of the opening in panel 1, forming in its assembled state a connection to panel 1 that is without axial play and a permanent fit formed by deformation (referred to herein as a positive fit). This applies to all embodiments of the invention.

The pipe section 2 includes a flange section 5 for frontally abutting panel 1. The flange section 5 includes a groove 6 on its front, especially a ring groove, for accommodating the seal 3. The seal 3 is formed from an O-ring.

The pipe section 2, flange section 5, and pipe socket 4 are constructed as one piece. The pipe socket 4 is constructed of a plastically ductile material for forming a connection with panel 1, the material comprising a thin-walled metal sheet, preferably of flangible brass. Moreover, a material such as a hot-workable plastic can also be used. The distribution of the force that occurs during plastic deformation is characterized by typical forces occurring during technical forming processes, such as plate bending or riveting.

On the end abutting the panel, the pipe socket 4 can include means, such as a threaded section 7, for fastening a tie-rod (not illustrated). By applying a tie force after the pipe socket 4 has been guided through the opening in the panel 1 (FIG. 1), using a tie-rod screwed to the inside thread of the threaded section 7, the pipe socket 4 can be deformed in such a manner that a tight positive fit connection without axial play arises (FIG. 2). A deformed section 8 engages the opening in the panel 1 on the edge of the flange section 5 of pipe socket 2 and the seal 3 is thus pressed tightly to the panel 1. The compression of seal 3 is referred herein as a non-positive fit (based on elastic deformation). For a deformed section 8 located in the interior in a container, the assembly of the pipe fitting according to invention can be performed externally through panel 1.

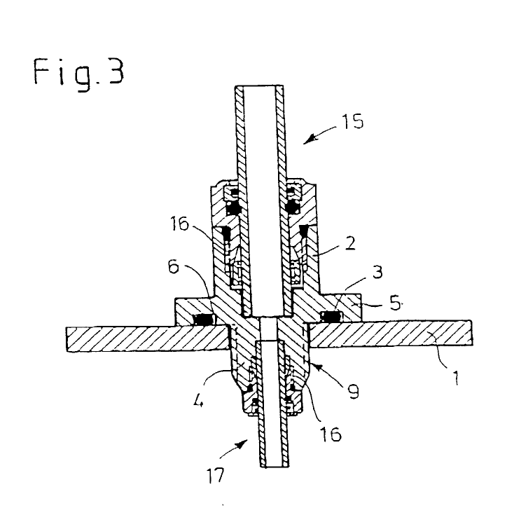

The second embodiment of the invention depicted in FIG. 3 differs from the first embodiment in the manner of how the connection between panel 1 and pipe socket 4 is designed. The connection being a positive fit and without axial play. Here too it involves a connection of positive and non-positive fit, the connection being achieved, however, because pipe socket 4 demonstrates a special self-grooving external thread 9 for connection to the panel 1. These types of threads are well known themselves, examples being found for sheet metal screws that are described in DIN 7971, 7982, and 7976. Here the screw connection ensures that the flange section 5 of pipe socket 2 together with the seal 3 is pressed tightly onto panel 1.

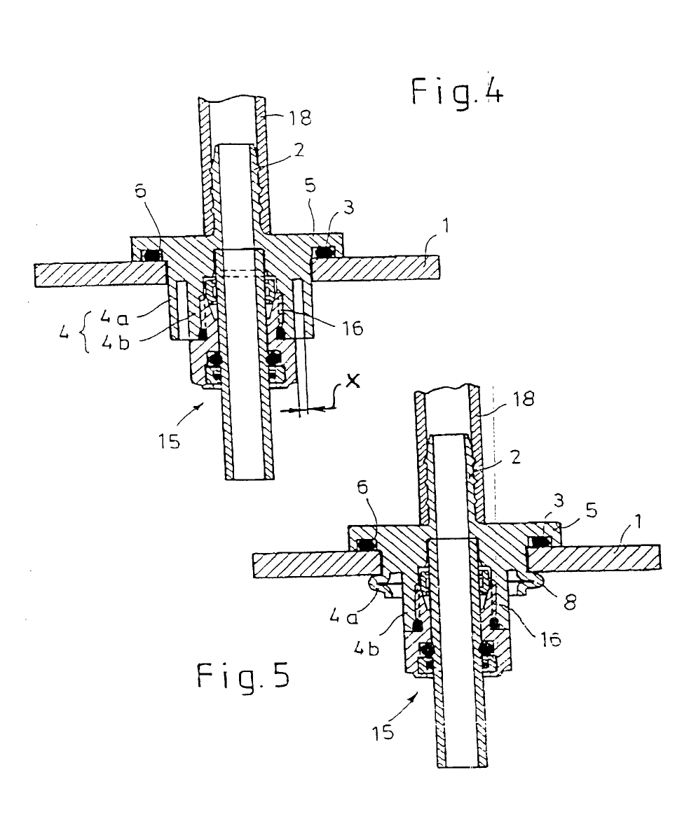

FIGS. 4 and 5 show a third embodiment of the invention. This is similar to the first embodiment of the invention, it being characteristic that the pipe socket 4 for forming the connection to panel 1 be designed double-walled. Pipe socket 4 comprises an outside pipe section 4a and an inside pipe section 4b which are arranged concentric and apart from each other (distance X between the inside wall of the outside pipe section 4a and the outside wall of the inside pipe section 4b), but connected to each other on the foot side (in an assembled state approximately in the plane of panel 1). The connection with panel 1 is thereby again of positive and non-positive fit, (as in the first embodiment) because a deformed section 8 engages the opening in the panel 1 on the edge. Flange section 5 of pipe socket 2 together with the seal 3 are thereby pressed tightly onto the panel 1. The deformed section 8 of pipe socket 4 is generated by an exclusive deformation (compression set or flanging outwards) of outside tube section 4a. In this embodiment, there exists a separation of the fastening function (threadless outside pipe section 4a) and the connecting function (inside pipe section 4b with thread 16) of the pipe fitting according to the invention, thereby optimizing the complete operation of the pipe fitting with respect to its reliability.

In accordance with the invention, it is not necessary to mount the pipe fitting to the panel 1 prior to a surface treatment, such as a coat of paint, nor is it necessary in the first and second embodiment of the invention for the panel 1 to be accessible on both sides for assembly.

In the embodiments of the invention, connecting pieces, such as the multipart mounting part 15 (depicted externally in FIGS. 1 to 3 and internally in FIGS. 4, 5) for connecting a pipeline can be connected to the pipe fitting in a manner that is itself well known. For example, the pipe fitting, as illustrated, can demonstrate the appropriate inside thread 16 or even locking means for constructing a quick connection. The connecting pieces can, as illustrated, be connected to the protruding pipe section 2 and the pipe socket 4 both inside and outside of panel 1. Thus FIGS. 1 through 3 show the mounting part 15 on pipe section 2 and a similar but smaller mounting part 17 on pipe socket 4. In the third embodiment of the invention, pipe section 2 is designed in such a manner that a hose pipe 18 can be easily attached onto it.

As is evident in FIGS. 6 to 8 which show a fourth embodiment of the invention, a pipe fitting for a panel 1 (especially a container wall 1a and that of a pressure reservoir) according to the invention hereto demonstrates a pipe section 2 protruding outward from the container wall 1a.

In its assembled state, the front of the pipe section 2 is similarly fastened tight to the container wall 1a with an intermediate layer forming a seal 3. A pipe socket 4 is provided on the pipe section 2 for passing through an opening (not illustrated in detail) in container wall 1a. The pipe socket 4, since it fits the size of the through-hole in container wall 1a, forms a connection to container wall 1 a that is without axial play and at least of positive fit.

As in the preceding embodiments, the pipe section 2 in accordance with the fourth embodiment of the invention includes a flange section 5 for frontally abutting the container wall 1a. The front of the flange section 5 includes a groove 6, particularly a ring groove, for accommodating the seal 3. The seal 3 is again preferably constructed from an O-ring.

The pipe section 2, flange section 5, and pipe socket 4 preferably consist of one piece of metal to form a connection with container wall 1a including a material that is plastically deformable when force is applied. The thin-walled metal sheet is preferably of flangible brass. The distribution of the force that occurs during plastic deformation is characterized by typical forces occurring during technical forming processes, such as plate bending or riveting.

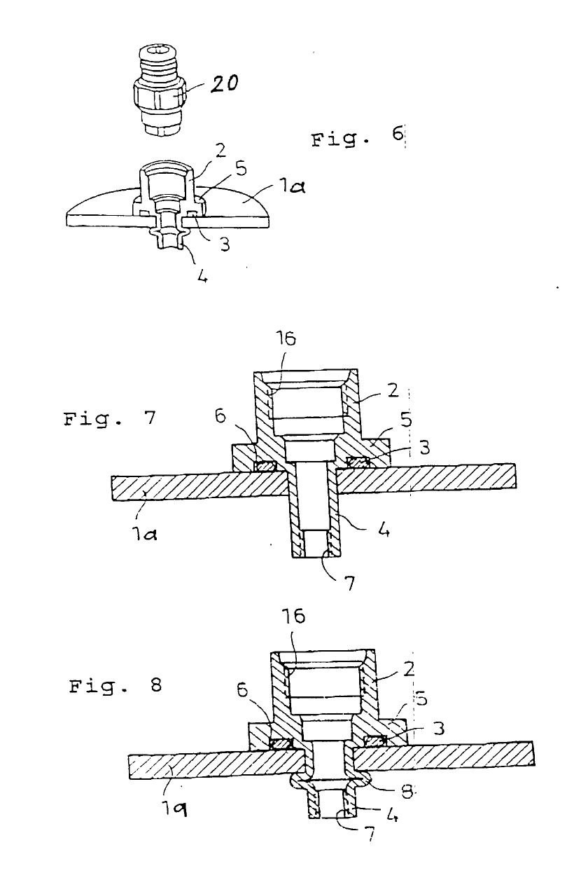

On its container sided end, the pipe socket 4 includes means, such as a threaded section 7, for fastening a tie-rod (not illustrated). By applying a tie force after the pipe socket 4 has been guided through the opening in the container wall 1 a (FIG. 7), the tie-rod is screwed to the inside thread of the threaded section 7. The tie rod can deform, in particular compress, pipe socket 4 such that a tight connection without axial play arises (FIG. 8). The connection with container wall la is consequently of positive and non-positive fit since a deformed section 8 of pipe socket 4 engages the opening in container wall 1a on the edge. The flange section 5 of pipe socket 2 along with the seal 3 are thus pressed tightly to the container wall 1a.

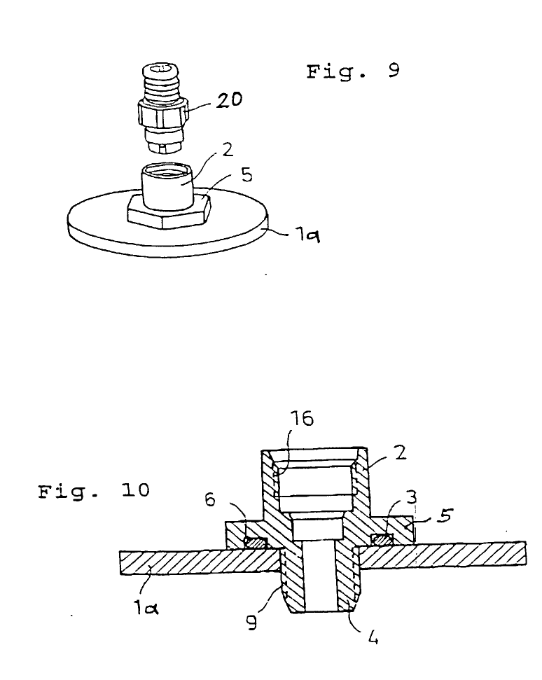

The fifth embodiment of the invention depicted in FIGS. 9 and 10 differs from the preceding illustrated embodiment in the manner of how the connection between container wall 1a and pipe socket 4 is designed. The connection being at least of positive fit and without axial play. Most previously described embodiments involved a connection of positive and non-positive fit (as in the second embodiment of the invention). The connection is achieved because the pipe socket 4 includes a special self-grooving external thread 9 for forming the connection to the container wall 1 a. As previously mentioned, these types of thread are well known themselves, examples being found for sheet metal screws (described in DIN 7971, 7982, and 7976). The fifth embodiment differs from the second embodiment of the invention in the type of inside contour of pipe section 2 and pipe socket 4.

FIGS. 11 through 13 show a sixth embodiment of the invention. For forming the connection with the container wall 1a, the pipe socket 4 should be radially elastic deformable and include locking means 10 on its end, including locking noses that are directed radially outward to engage the edge of the opening in the container wall l a in the assembled state, and cooperate with the inside of container wall 1a. To achieve the radial elastic deformability, pipe socket 4 includes a multiple axial slot 11, as illustrated in FIG. 12.

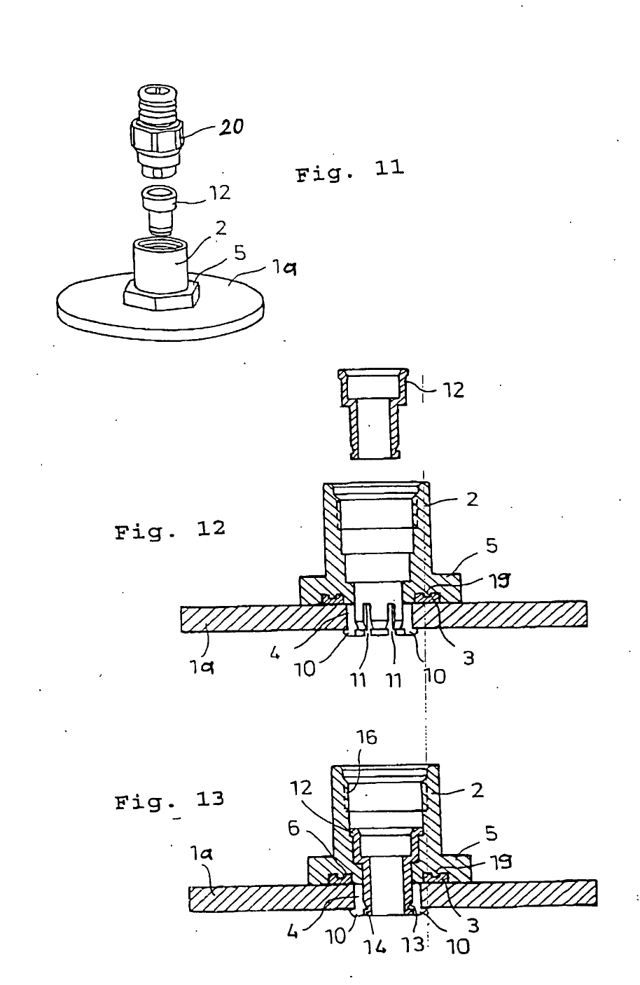

A hollow expanding body 12 can be inserted into the pipe socket 4 and locked with the pipe socket 4. Pipe socket 4, once its slotted vicinity has been fed inwards through the opening in container wall 1a under radial deformation (FIG. 12) can, by inserting and locking the expanding body 12, be fixed in such a manner that a tight connection without axial play arises (FIG. 13). A compression bead 19, which is arranged by shaping on the base of groove 6, presses the O-ring in such a manner that pipe socket 4 is prestressed.

To form the locking connection between expanding body 12 and pipe socket 4, both parts demonstrate corresponding locking means 13, 14 that cooperate with each other, like an inside shoulder 13 in pipe socket 4 and an outside bead 14 on expanding body 12 as illustrated in FIG. 13. In the sixth embodiment of the invention, it is possible to achieve a non-positive connection between the pipe fitting and container wall 1a (which presses the flange section 5 of pipe socket 2 together with the seal 3 tight onto the container wall 1a), which is superimposed on the positive locking, by suitably designing the locking means 10, 13 of pipe socket 4 to lock with both container wall 1a and expanding body 12, and locking means 14 of expanding body 12 to lock with the pipe socket 4 by having the locking means 10, 13, 14. Each demonstrates slanted surfaces that cause both radially and axially operating forces of different size to be present in the locking connection.

In accordance with the invention, it is unnecessary to mount the pipe fitting on the container wall 1a prior to a surface treatment, such as a coat of paint. Nor is it necessary for container wall 1a to be accessible on both sides for assembly.

In the third through sixth embodiments, it is also possible to connect a connecting piece 20, such as the illustrated mounting part, to the pipe fitting for the purpose of connecting a pipeline. The pipe fitting can demonstrate an appropriate inside thread 16 as illustrated, or again demonstrate locking means for constructing a quick connection.

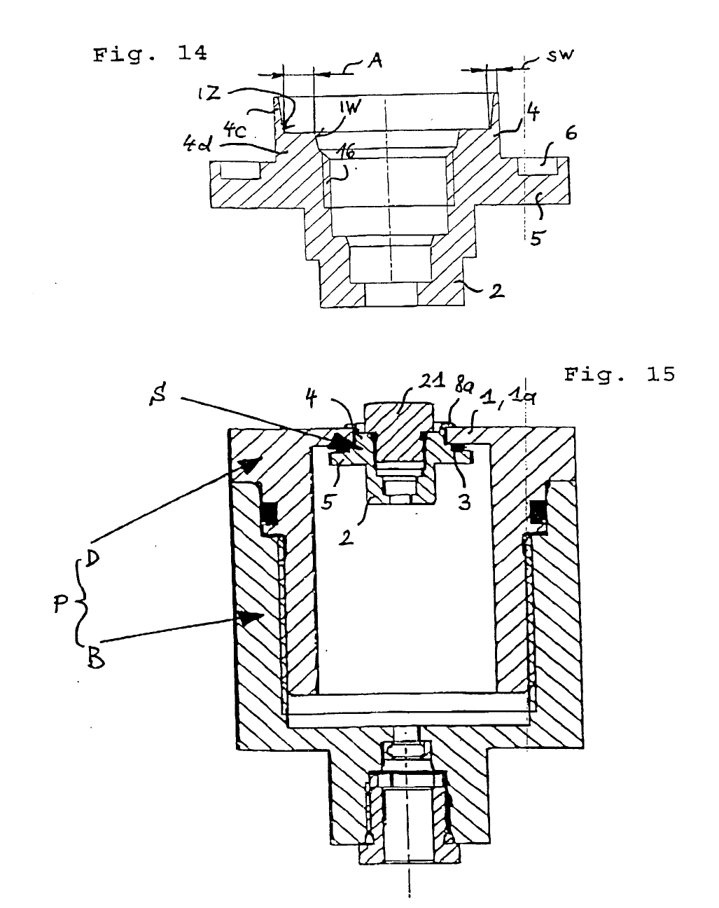

In the seventh embodiment of a pipe fitting according to the invention depicted in FIGS. 14 through 17, a variant in which the pipe socket 4 forms the connection with the panel 1, includes a material that is at least partially plastically deformable when force is applied.

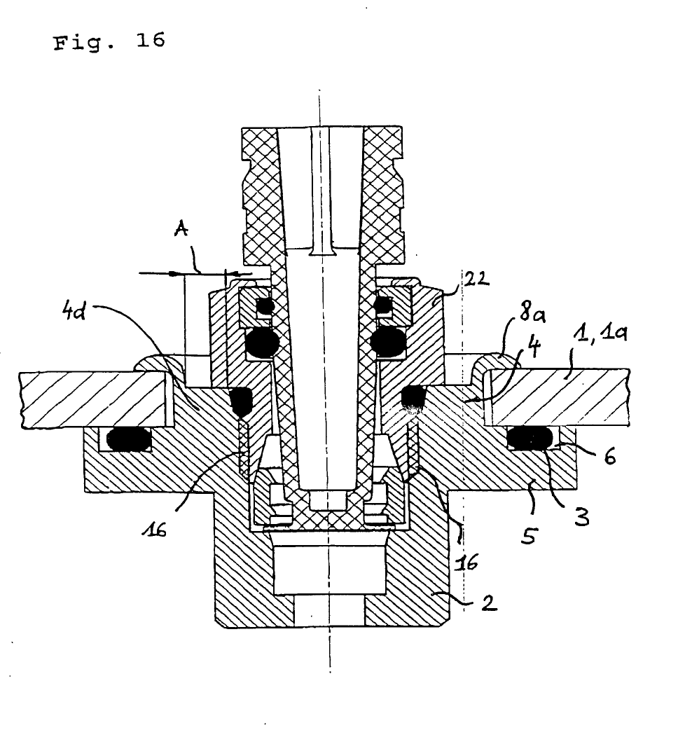

In FIG. 15, the pipe fitting according to the invention (labeled with the reference character S) is in the final stage of assembly in a pressure reservoir P which consists of a base section B and a lid section D. The lid section D engages the base section B so that the reservoir P provides a double wall. The pipe fitting S is mounted in a panel 1 of lid section D and locked with a plug section 21.

In contrast to the other variants with a flangible pipe socket 4, in this embodiment pipe socket 4 is not equipped with a center section for flanging. Rather, the end of pipe socket 4 is equipped with a ring-shaped flange section 4c (FIG. 14) which is flanged centrically outward during assembly and consequently rests like a collar on the panel 1 in the assembled state (see FIG. 15 and especially FIG. 16, labeled with reference character 8a). In the illustrated embodiment, the flange appears on the exterior of lid D of pressure reservoir P.

In this embodiment there also preferably exists a separation of the fastening function and connection function of the pipe fitting according to invention S, thereby optimizing the complete operation of the pipe fitting with respect to its reliability. The functional separation is accomplished on one end by the terminal location of flange section 4c. Flange section 4c also demonstrates an inside diameter on its other end that is opposite the other inside diameter and extended to a base section 4d of pipe socket 4 so that it can again include an inside thread 16 between the inside wall IW of base section 4d for connecting to a connecting piece 20, 22, so that a clearance A to the inside wall IZ (diameter at its foot) of flange section 4c exists. This axial clearance A forms a ring whose surface is sufficiently large to function as a front bearing surface for a connecting piece 20, 22, like the plug section 21 shown in FIG. 15 or the connecting piece 22 shown in FIG. 16. The ring engages the base section 4d and the mounted connected piece 20, 22, not coming into contact with the flanging 8a.

In the spirit of better implementation of the flanging, the wall thickness sw of flange section 4c can preferably taper from the foot of base section 4c. This is located on base section 4d and toward the open end of base section 4c, as depicted in FIG. 14.

This last characteristic mentioned above could also be realized in connection with the embodiment illustrated in FIGS. 4 and 5. It can likewise be interpreted in such a manner that it features a flanged-up flange section (reference character 4a in this case) and a base section (reference character 4b). Thereto the flange section 4a could likewise be designed so that no buckling, but rather a collar-like flaring would arise.

The invention is not limited to the illustrated exemplary embodiments, but comprises all embodiments that work in the same spirit as the invention. Thus various seals can be used on the pipe fitting. As FIGS. 1, 3, 4, 15 and 16 show in particular, the most different kinds of well-known connections can be realized both on or in pipe section 2 (located interior or exterior relative to the panel 1) and on pipe socket 4 (located interior or exterior relative to the panel 1), such as the connection depicted in FIG. 16. The connecting piece 22 is screwed to base section 4d by means of thread 4d and accommodates additional mounting parts.

Moreover, the invention is not restricted to the combination of characteristics defined in claim 1, but can be defined by any other desired combination of characteristics of all individual characteristics disclosed as a whole. This means that basically any single characteristic of claim 1 may be omitted and replaced by at least one characteristic disclosed at another place in the application. To this extent, claim 1 is to be understood only as a first attempt at formulating an invention.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. Pipe fitting for a panel (1), especially for a panel (1, 1a) of a lid or container, such as a container wall (1a), with a pipe section (2) protruding from said panel (1, 1a),
characterized in that the front of said pipe fitting (2) is fastened tight to said panel (1, 1a) in the assembled state, an intermediate layer forming a seal (3) and a pipe socket (4) existing on said pipe section (2) for passing through an opening in said panel (1, 1a), which pipe socket (4) forms a connection to said panel (1, 1a) in the assembled state without axial play and at least of positive fit.

2. Pipe fitting according to claim 1,
characterized in that a non-positive lock is superimposed on the positive locking between said pipe socket (4) and said panel (1, 1a).

3. Pipe fitting according to claim 1 or 2,
characterized in that said pipe section (2) demonstrates a flange section (5) for frontally abutting said panel (1, 1a).

4. Pipe fitting according to one of the claims 1 through 3,
characterized in that said pipe section (2), possibly said flange section (5), and said pipe socket (4) comprise of one piece of metal or of a deformable plastic.

5. Pipe fitting according to one of the claims 1 through 4,
characterized in that said pipe section (2), particularly said flange section (5), demonstrates a groove (6) on its front, especially a ring groove, for accommodating said seal (3).

6. Pipe fitting according claims 5,
characterized in that a compression bead (19) for said seal (3) is arranged in said groove (6).

7. Pipe fitting according to one of the claims 1 through 6,
characterized in that said seal (3) is formed from an O-ring.

8. Pipe fitting according to one of the claims 1 through 7,
characterized in that said pipe socket (4) demonstrates an external thread (9) like a sheet metal screw for forming the connection to said panel (1, 1a).

9. Pipe fitting according to one of the claims 1 through 7,
characterized in that said pipe socket (4), to form a connection to said panel (1, 1a), comprises of a material that is at least somewhat plastically deformable when force is applied, preferably of flangible brass.

10. Pipe fitting according to claim 9,
characterized in that on its panel-sided end, said pipe socket (4) demonstrates means, such as a threaded section (7), for fastening a tie-rod.

11. Pipe fitting according to one of the claims 1 through 7, 9, or 10,
characterized in that said pipe socket (4) comprises of an outside pipe section (4a) and an inside pipe section (4b), which are arranged concentric to each other and connected to each other on the foot side, at least said outside pipe section (4a) comprising of a material that is plastically deformable when force is applied.

12. Pipe fitting according to one of the claims 1 through 7, or 9 through 11,
characterized in that the end of said pipe socket (4) demonstrates a ring-shaped flange section (4a, 4c), which is flanged centrically outward, and a base section (4b, 4d).

13. Pipe fitting according to claim 12,
characterized in that the wall thickness (sw) of said flange section (4c) tapers from a foot located on said base section (4c) toward the open end of said base section (4c).

14. Pipe fitting according to claim 12 or 13,
characterized in that said flange section (4a, 4c) and said base section (4b, 4d) are arranged at an axial distance (X, A) from each other.

15. Pipe fitting according to one of the claims 1 through 14,
characterized in that said pipe section (2) and/or said pipe socket (4) demonstrate an inside thread (16) for screwing a mounting part (20) or a connecting piece (15, 17) for a pipeline.

16. Pipe fitting according to one of the claims 1 through 15,
characterized in that said pipe section (2) is designed in such a manner that a hose pipe (18) can be attached thereto.

17. Pipe fitting according to one of the claims 1 through 7,
characterized in that for forming the connection with said panel (1, 1a), said pipe socket (4) is radially elastic deformable and demonstrates locking means (10) on its end for cooperating with the inside of said panel (1, 1a).

18. Pipe fitting according to claims 17,
characterized in that said pipe socket (4) demonstrates a multiple axial slot (11) for achieving the radial elastic deformability.

19. Pipe fitting according to claims 17 or 18,
characterized by a hollow expanding body (12) that can be inserted into said pipe socket (4) and locked with said pipe socket (4).

20. Pipe fitting according to one of the claims 1 through 19,
characterized in that said panel (1, 1a) is a wall (1a) of a pressure reservoir (P) from which said pipe section (2) protrudes inwards or outwards.
